(19) United States
(12) Patent Application Publication
(10) Pub. No.: US 2019/0032897 A1
(43) Pub. Date: Jan. 31, 2019

(54) LIGHTING DEVICE, AND ANIMALS-AND-PLANTS-FARMING LIGHT CONTROL SYSTEM

(71) Applicant: Panasonic Intellectual Property Management Co., Ltd., Osaka (JP)

(72) Inventor: Bo CAO, Beijing (CN)

(21) Appl. No.: 16/047,972

(22) Filed: Jul. 27, 2018

(30) Foreign Application Priority Data
Jul. 28, 2017 (CN) 201720939324.0

(51) Int. Cl. F21V 19/00; F21V 23/00; A01K 45/00; A01G 7/04

(52) U.S. Cl. CPC F21V 19/001; F21V 23/003; F21Y 2115/10; A01G 7/045; A01K 45/00

(57) ABSTRACT

A lighting device includes: one or more printed circuit boards (PCBs) on which a green light emitting diode (LED) particle module, a blue LED particle module, and a white LED particle module are mounted.

### CROSS REFERENCE TO RELATED APPLICATION

The present application claims the benefit of Chinese Patent Application No. 2017209393240 filed Jul. 28, 2017. The entire disclosure of the above-identified application, including the specification, drawings and claims is incorporated herein by reference in its entirety.

### FIELD

The present disclosure relates to a lighting field, and particularly to lighting devices and farming light control systems.

### BACKGROUND

Light irradiation is one of important environmental conditions in the process of growth of poultry. Light rays having different color temperatures cause extremely important effects on the growth of the poultry. Thus, there have been increasing user needs on light irradiation control in farming environments. For example, in processes for farming poultry such as broilers and ducks in farming places, in general, the poultry are irradiated with light so that the growth thereof is accelerated.

### SUMMARY

### Technical Problem

Lighting devices used in conventional farming places are each a lighting device having a row of LEDs, only includes light sources suitable for the growth of the broilers, ducks, etc., but do not allow adaptation of human naked eyes, and thus these light sources must be turned off when farming houses need to be cleaned up. However, such farming houses are generally sealed spaces, and the light rays inside thereof become weak when the light sources are turned off. This limit human activities, and thus user experiences provided by the lighting devices are undesirable.

In view of this, the technical problem to be solved by the present disclosure is to provide a lighting device and a farming light control system that allow a user to select different light irradiation modes in different scenes and to further provide better user experiences.

### Solution to Problem

In order to solve the above-described technical problem, according to an embodiment of the present disclosure, a lighting device is provided. The lighting device includes: one or more printed circuit boards (PCBs) on which a green light emitting diode (LED) particle module, a blue LED particle module, and a white LED particle module are mounted.

In a method that can be implemented, in the lighting device, a ratio of the number of particles in the green LED particle module, the number of particles in the blue LED particle module, and the number of particles in the white LED particle module is 5:4:6.

In a method that can be implemented, the green LED particle module, the blue LED particle module, and the white LED particle module on each of the one or more PCBs are arranged in parallel to each other, the green LED particle module includes three groups of green LED particles arranged in parallel to each other, the blue LED particle module includes two groups of blue LED particles arranged in parallel to each other, and the white LED particle module includes three groups of white LED particles arranged in parallel to each other.

In a method that can be implemented, fifteen green LED particles, twelve blue LED particles, and eighteen white LED particles are provided on each of the one or more PCBs.

In a method that can be implemented, green LED particles and blue LED particles are provided along a first straight line on each of the one or more PCBs, and white LED particles are evenly provided along a second straight line of the PCB, and the first straight line and the second straight line are parallel to each other, and each of the first straight line and the second straight line is parallel to a long side of the PCB.

In a method that can be implemented, one or two of the green LED particles are provided between every two of the blue LED particles.

In a method that can be implemented, the one or more PCBs in the lighting device comprise two PCBs.

In order to solve the technical problem, according to another aspect of the present disclosure, a farming light control system including the lighting device is provided.

In a method that can be implemented, the farming light control system further includes a control module. The control module causes the lighting device to switch between a first mode and a second mode, based on a mode switch signal. In the first mode, green LED particles and blue LED particles emit light, and white LED particles do not emit light; and in the second mode, the white LED particles emit light, and the green LED particles and the blue LED particles do not emit light.

In a method that can be implemented, the first mode is a farming mode, and the second mode is a cleaning mode.

### Advantageous Effects

A lighting device according to the present disclosure includes three kinds of LED particle modules having different colors that are a green LED particle module, a blue LED particle module, and a white LED particle module. With these modules, the lighting device and the farming light control system can provide different kinds of spectra and light irradiation intensities, which allows a user to select any of the spectra and intensities according to an application need, helps the user to perform operations, and provides better user experiences.

### BRIEF DESCRIPTION OF DRAWINGS

Based on details of exemplary embodiments explained with reference to the drawings below, other features and aspects of the present disclosure are clarified.

The drawings are intended to indicate the exemplary embodiments, the features, and the aspects of the present disclosure together with the Description so as to explain the principles of the present disclosure.

FIG. 1 is a diagram illustrating a configuration of a lighting device according to the present disclosure.

FIG. 2 is a diagram illustrating a configuration of a lighting device according to the present disclosure.

FIG. 3 is a diagram illustrating connection of LED particles of a lighting device according to the present disclosure.

FIG. 4 is a diagram illustrating a farming light control system according to the present disclosure.

### DESCRIPTION OF EMBODIMENTS

Hereinafter, exemplary embodiments, features, and aspects are described in detail with reference to the drawings. In the drawings, the same reference signs denote the same or similar functional elements. Although the respective aspects of the embodiments are illustrated in the drawings, there is no need to illustrate them according to the reduced scales unless otherwise specified.

Here, the term “exemplary” indicates “an example, an embodiment, or use for illustrative purpose”. Any of the embodiments explained as an “exemplary” one here should not be interpreted as being preferable to or more advantageous than the other embodiments.

In addition, in order to explain the present disclosure better, a number of specific details are indicated in the specific aspects below. Any person ordinarily skilled in the art should appreciate that the present disclosure can be implemented in the same manner irrespective of these specific details. Methods, means, elements, and circuits which have been well known by any person ordinarily skilled in the art are not explained in detail in some of the embodiments, in order to clarify the scope of the present disclosure.

### Embodiment 1

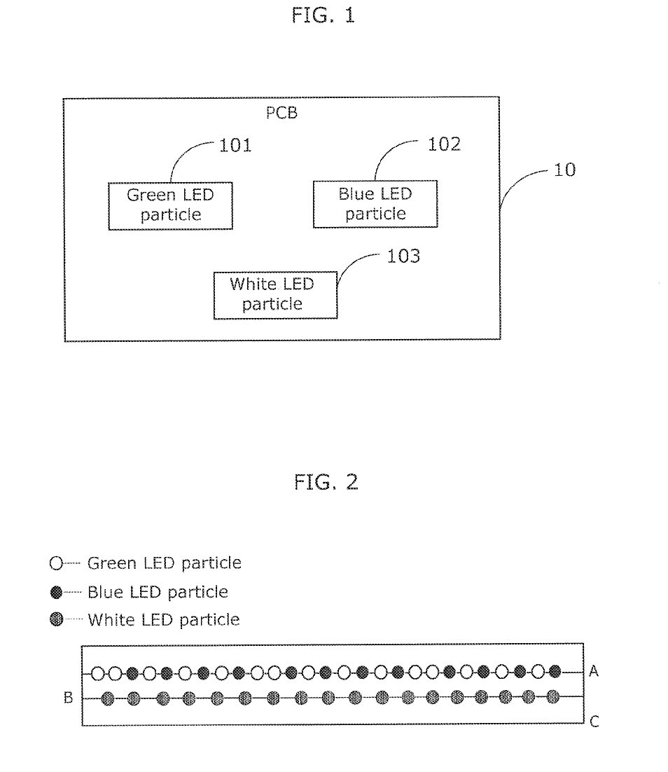

FIG. 1 is a diagram illustrating a configuration of a lighting device according to an embodiment of the present disclosure. The lighting device is applicable in a farming environment and in other environments, and the present disclosure is not limited thereto.

As illustrated in FIG. 1, the lighting device mainly includes one or more printed circuit boards (PCBs) 10 on each of which a green LED particle module 101, a blue LED particle module 102, and a white LED particle module 103 are provided.

In a method that can be implemented, only the green LED particle module 101, the blue LED particle module 102, and the white LED particle module 103 are provided on the PCB 10, and no LED particle module having any other color is included.

In a method that can be implemented, the green LED particle module 101, the blue LED particle module 102, and the white LED particle module 103 are each controlled individually to emit light having a different spectrum. In an exemplary case where a lighting device is applied in a broiler (such as white-feather chickens and Gushi chickens) farming environment, in the farming mode, it is possible to perform control so that each of the green LED particle module 101 and the blue LED particle module 102 emits light, and adjust the light emission rate and/or the light emission intensities of the green LED particle module 101 and the blue LED particle module 102 in different farming stages, so as to provide different spectra and light emission intensities in the different farming stages. On the precondition that the growth cycle is unchanged, it is possible to achieve effects of increasing the weights of growing-up broilers and increasing the growth rates. After a farming cycle is completed, control is performed so that the white LED particle module 103 emits light and the green LED particle module 101 and the blue LED particle module 102 are turned off. This control is useful for a farming worker to perform operations of cleaning, disinfection, etc. in the farming environment in a general white light environment.

An example is given. The lighting device provided by the present disclosure includes three rows of light sources. One of the rows includes only a green LED particle module 101, another one of the rows includes only a blue LED particle module 102, and the other one of the rows includes only a white LED particle module 103. The light sources in each row include one or more same-color LED particles. Here, the three rows of light sources are controlled independently so that they can emit white light having a single-color spectrum with which surroundings thereof can be irradiated, or they can form different spectra by combining a plurality of colors. The light irradiation intensities of the respective light sources in each row can be controlled. When two different-color LED particle modules are combined, light emitted by the LED particles having different colors in the combination can correspond to different spectra and light irradiation intensities. In other words, the lighting device according to the present disclosure provides different kinds of spectra and light irradiation intensities that can be selected by a user according to application needs.

A person ordinarily skilled in the art can provide a given number of PCBs in the lighting device as necessary, for example, provide two PCBs, but it is to be noted that the present disclosure is not limited thereto.

Although the lighting device has been described taking FIG. 1 as an example, it is to be noted that a person ordinarily skilled in the art should appreciate that the present disclosure is not limited thereto. In fact, the user can flexibly set the numbers of green, blue, and white LED particles and a position relationship thereof according to fully individual preference and/or an actual application scene.

In this way, it is possible to provide three kinds of different-color LED particles which are green LED particles, blue LED particles, and white LED particles in the lighting device, and provide the plurality of kinds of different spectra and light irradiation intensities so that they can be selected by the user according to application needs in different scenes. Thus, the lighting device can provide better user experiences according to the embodiment of the present disclosure. For example, in a scene of a farming place, a user can select, as a cleaning mode, a light irradiation mode for causing only a white LED particle module to emit light, select a farming mode in which a green LED particle module and/or a blue LED particle module emit(s) light. Different light irradiation conditions are provided in different farming stages according to different farming modes.

FIG. 2 is a diagram illustrating a configuration of a lighting device according to an embodiment of the present disclosure. In FIG. 2, the elements having the same reference signs as in FIG. 1 have the same functions, and detailed descriptions of these elements are omitted for simplicity.

As illustrated in FIG. 2, in a method that can be implemented, the ratio between the number of LED particles in the green LED particle module 101, the number of LED particles in the blue LED particle module 102, and the number of LED particles in the white LED particle module 103 in the lighting device is 5:4:6. For example, 15 green LED particles, 12 blue LED particles, and 18 white LED particles are provided on the PCB 10 illustrated in FIG. 2.

A person ordinarily skilled in the art should appreciate that the case where 15 green LED particles, 12 blue LED particles, and 18 white LED particles are provided on the PCB 10 is a mere example of the present disclosure, and should not interpret that the example limits the present disclosure. In fact, it is only necessary that the ratio between the number of LED particles in the green LED particle module, the number of LED particles in the blue LED particle module, and the number of LED particles in the white LED particle module in the lighting device is 5:4:6. For example, 20 green LED particles, 16 blue LED particles, and 24 white LED particles may be provided on the PCB 10. The present disclosure is not specifically limited. A person ordinarily skilled in the art determines the details according to an actual need.

Setting the ratio of different-color LED particles as described above is useful for adjusting the ratio of light emission by different-color LEDs in an actual use and enables obtainment of a corresponding spectrum.

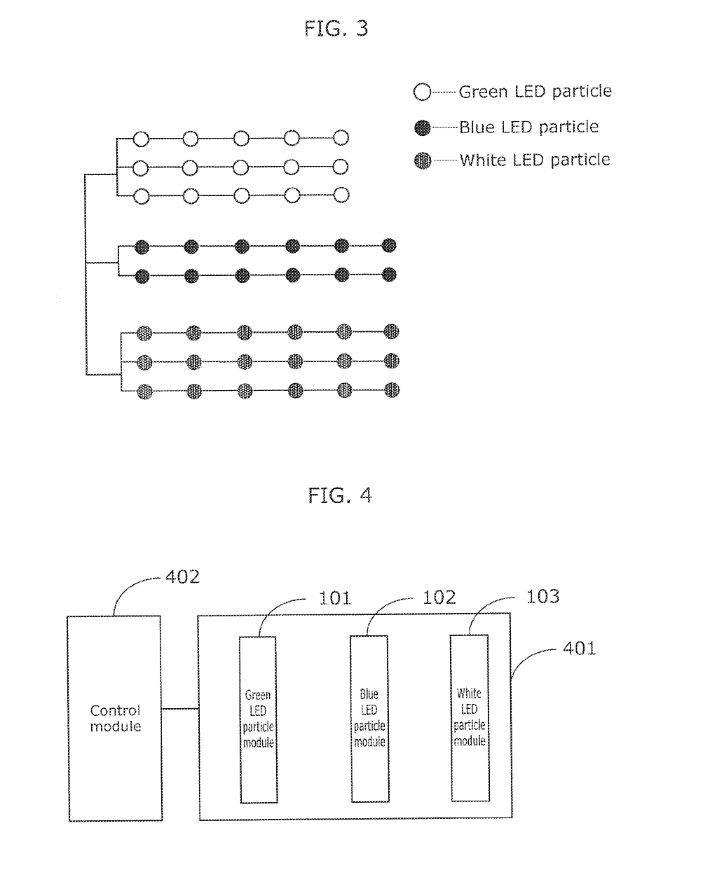

FIG. 3 is a diagram illustrating connection of LED particles of a lighting device according to an embodiment of the present disclosure. In a method that can be implemented: in the lighting device illustrated in FIG. 3, the green LED particle module 101, the blue LED particle module 102, and the white LED particle module 103 are parallel to each other on the PCB 10; and the green LED particle module 101 includes three groups of green LED particles arranged in parallel to each other, the blue LED particle module 102 includes two groups of blue LED particles arranged in parallel to each other, and the white LED particle module 101 includes three groups of white LED particles arranged in parallel to each other.

An example of 15 green LED particles, 12 blue LED particles, and 18 white LED particles is given. Three groups of green LED particles are obtained when five green LED particles are connected in series for each group, and when these three groups of green LED particles are arranged in parallel to each other, the green LED particle module 101 having the three groups of green LED particles arranged in parallel to each other is obtained. Two groups of blue LED particles are obtained when six blue LED particles are connected in series for each group, and when these two groups of blue LED particles are arranged in parallel to each other, the blue LED particle module 102 having the two groups of blue LED particles arranged in parallel to each other is obtained. Three groups of white LED particles are obtained when six white LED particles are connected in series for each group, and when these three groups of white LED particles are arranged in parallel to each other, the white LED particle module 103 having the three groups of white LED particles arranged in parallel to each other is obtained.

In this way, it is possible to control the three kinds of different-color LEDs independently by arranging the three modules of the green LED particle module, the blue LED particle module, and the white LED particle module in parallel to each other, and it is possible to control the light irradiation intensity of a single color light source by grouping the LED particles under each color and arranging them in parallel to each other.

When causing different-color combinations of LED particle modules to emit light, it is possible to adjust the numbers of light-emitting particles of the respective different-color LED particle modules by independently controlling a given LED particle combination in one or more kinds of the different-color LED particle modules. In this way, it is possible to adjust the spectra and irradiation intensities of emission light. An example of a combination of the green LED particle module 101 and the blue LED particle module 102 is given. As illustrated in FIG. 3, it is possible to perform control so that a group of green LED particles and two groups of blue LED particles emit light simultaneously, or a group of green LED particles and a group of blue LED particles emit light simultaneously.

The lighting device according to the present disclosure is capable of providing different light irradiation conditions to achieve different spectra and light irradiation intensities which are required in different farming stages or farming modes. The above connection methods are mere examples, and the present disclosure is not limited to any methods. A person ordinarily skilled in the art can use other connection methods as necessary.

In a method that can be implemented, green LED particles and blue LED particles are provided along a first straight line A on the PCB 10, and white LED particles are evenly provided along a second straight line B on the PCB 10. Here, the first straight line A and the second straight line B are parallel to each other, and each of the first straight line A and the second straight line B is parallel to a long side C of the PCB 10.

It is to be noted that the above connection methods are mere examples, and the present disclosure is not limited to any methods. It is advantageous that a person ordinarily skilled in the art can set a method for arranging LED particles according to the shape and size of a PCB, etc., and achieve even light emission.

In a method that can be implemented, the green LED particles and the blue LED particles are provided spaced apart along the first straight line A on the PCB 10, and one or two of the green LED particles are provided between every two of the blue LED particles. As illustrated in FIG. 3, an exemplary method for providing green LED particles and blue LED particles along the first straight line A on the PCB 10 when the ratio between the number of green LED particles and the number of blue LED particles provided on the PCB 10 is 5:4 is to connect them in the following order: a green LED particle, a blue LED particle, a green LED particle, a blue LED particle, a green LED particle, a green LED particle, a blue LED particle, a green LED particle, and a blue LED particle.

The method for providing the green LED particles and the blue LED particles on the PCB 10 should be appreciated as a mere example of the present disclosure, and should not be interpreted as limiting the method for providing the green LED particles and the blue LED particles spaced apart in the present disclosure. Any other method for mixing blue light and green light comparatively evenly is possible substantially. For example, the green LED particles and the blue LED particles may be provided in the following order: a green LED particle, a green LED particle, a blue LED particle, a green LED particle, a blue LED particle, a green LED particle, a blue LED particle, a green LED particle, and a blue LED particle. Embodiments of the present disclosure are not specifically limited thereto, and are determined by a person ordinarily skilled in the art according to an actual need.

In this way, different kinds of spectra and light irradiation intensities are provided by providing the lighting device with three kinds of LED particle modules of the green LED particle module, the blue LED particle module, and the white LED particle module. The user can select different light emission methods in different application scenes. The lighting device according to the present disclosure provides better user experiences. For example, when the lighting device is applied in a farming place, the user selects, as a cleaning mode, a light irradiation mode corresponding to light emission by the white LED particles, or selects, as a farming mode, a light irradiation mode corresponding to the green LED particles and/or the blue LED particles.

FIG. 4 is a diagram illustrating a farming light control system including a lighting device 401, according to an embodiment of the present disclosure.

In a method that can be implemented, the system includes a control module 402 which controls the lighting device 401 based on a mode switch signal so that the lighting device 401 switches between a first mode and a second mode. Here, the green LED particles and the blue LED particles emit light and the white LED particles do not emit light in the first mode, and the white LED particles emit light and the green LED particles and the blue LED particles do not emit light in the second mode.

Here, the first mode is the farming mode, and the second mode is the cleaning mode. Although the farming mode is a broiler farming mode, the farming mode may be a farming mode for farming other birds, plants, etc., and the present disclosure is not limited thereto.

An example is given. At an intermediate interval between two neighbouring farming cycles or in a process of a farming cycle, a poultry house needs to be disinfected or cleaned hygienically. Light irradiation for continuously using a farming mode is not suitable as a light irradiation mode at this time. A user selects the button for starting the cleaning mode by an input device such as a touch panel in the farming light control system. The input device such as the touch panel transmits a mode switch signal to the control module 402, based on the user input. The control module 402 switches a current lighting mode from the farming mode to the cleaning mode, based on the mode switch signal, transmits a control instruction to the lighting device 401 so as to cause the lighting device 401 to switch to the cleaning mode. In the cleaning mode, the LED particles in the white LED particle module 103 emit light, and the LED particles in the green LED particle module 101 and the blue LED particle module 102 do not emit light. At this time, white light irradiation in general lighting is used in the farming environment, and the light irradiation conditions are suitable for cleaning performed by the farming worker in the poultry house.

After the cleaning is completed, the lighting mode is switched to the farming mode by means of the user selecting the button for starting the farming mode. The input device such as the touch panel detects the user input, and transmits a mode switch signal to the control module 402, based on the user input. The control module 402 transmits a control signal to the lighting device 401 based on the mode switch signal, so as to cause the lighting device 401 to switch to the farming mode. In the farming mode, the LED particles in the white LED particle module 103 do not emit light and the LED particles in the green LED particle module 101 and/or the blue LED particle module 102 emit light.

In this way, it is possible to provide different needs for light irradiation in different operation modes and to provide different user experiences by adjusting the different operation modes of the lighting devices.

The farming light control system provided by the present disclosure provides different spectra and light irradiation intensities by controlling the light emission states of different color light sources in a lighting device. In this way, the user can select different light emission methods according to different needs in different application scenes. The farming light control system according to the embodiment of the present disclosure is capable of providing better user experiences. For example, when a person performs cleaning, an operation of a control-target lighting device is switched to a cleaning mode to provide irradiation with light suitable for human eyes, thereby providing better user experiences. At the time of farming, the operation mode of the lighting device is switched to the farming mode so as to be adapted for the growth of poultry or irradiation of light to be produced, and to further increase the amount of production. The operation modes can also be switched by controlling the lighting device.

As described above, the scope of the present disclosure is not limited to specific embodiments of the present disclosure. A person ordinarily skilled in the art may be able to easily arrive at modifications and replacements within the technical scope of the present disclosure, and thus any of such modifications and replacements is encompassed by the present disclosure. Accordingly, the scope of the present disclosure for patent protection is based on the scope of protection of the claims.

1. A lighting device, comprising:
one or more printed circuit boards (PCBs) on which a green light emitting diode (LED) particle module, a blue LED particle module, and a white LED particle module are mounted.

2. The lighting device according to claim 1,
wherein a ratio of the number of particles in the green LED particle module, the number of particles in the blue LED particle module, and the number of particles in the white LED particle module is 5:4:6.

3. The lighting device according to claim 2,
wherein the green LED particle module, the blue LED particle module, and the white LED particle module on each of the one or more PCBs are arranged in parallel to each other,
the green LED particle module includes three groups of green LED particles arranged in parallel to each other,
the blue LED particle module includes two groups of blue LED particles arranged in parallel to each other, and
the white LED particle module includes three groups of white LED particles arranged in parallel to each other.

4. The lighting device according to claim 3,
wherein fifteen green LED particles, twelve blue LED particles, and eighteen white LED particles are provided on each of the one or more PCBs.

5. The lighting device according to claim 1,
wherein green LED particles and blue LED particles are provided along a first straight line on each of the one or more PCBs, and white LED particles are evenly provided along a second straight line of the PCB, and
the first straight line and the second straight line are parallel to each other, and each of the first straight line and the second straight line is parallel to a long side of the PCB.

6. The lighting device according to claim 5,
wherein one or two of the green LED particles are provided between every two of the blue LED particles.

7. The lighting device according to claim 1,
wherein the one or more PCBs in the lighting device comprise two PCBs.

8. A farming light control system, comprising:
the lighting device according to claim 1.

9. The farming light control system according to claim 8, further comprising:
a control module, and
the control module causes the lighting device to switch between a first mode and a second mode, based on a mode switch signal:
in the first mode, green LED particles and blue LED particles emit light, and white LED particles do not emit light; and
in the second mode, the white LED particles emit light, and the green LED particles and the blue LED particles do not emit light.

10. The farming light control system according to claim 9,
wherein the first mode is a farming mode, and the second mode is a cleaning mode.
